(19) United States
(12) Patent Application Publication
(10) Pub. No.: US 2015/0358041 A1
(43) Pub. Date: Dec. 10, 2015

(54) CALIBRATION AND TUNING FOR A TUNABLE FILTER HAVING ADJUSTABLE INDUCTANCE AND CAPACITANCE

(71) Applicant: QUALCOMM Incorporated, San Diego, CA (US)

(72) Inventors: Meng Li, San Diego, CA (US); Kevin Hsi-huai Wang, San Diego, CA (US); Ryan Scott Castro Spring, San Diego, CA (US); Himanshu Khatri, Laguna Niguel, CA (US); Hong-Ming Lee, San Diego, CA (US)

(21) Appl. No.: 14/297,761

(22) Filed: Jun. 6, 2014

(51) Int. Cl. H04B 1/10

(52) U.S. Cl. CPC H04B 1/1036

(57) ABSTRACT

A device includes a tunable filter having an adjustable inductance and an adjustable capacitance, the tunable filter having a first tuning input responsive to a first control signal related to filter frequency band information, and a second tuning input responsive to a second control signal related to a jammer signal.

### BACKGROUND

1. Field

The present disclosure relates generally to electronics, and more specifically to transmitters and receivers.

2. Background

In a radio frequency (RF) transceiver, a communication signal is typically received and downconverted by receive circuitry, sometimes referred to as a receive chain. A receive chain typically includes a receive filter, a low noise amplifier (LNA), a mixer, a local oscillator (LO), a voltage controlled oscillator (VCO), a baseband filter, and other components, to recover the information contained in the communication signal. The transceiver also includes circuitry that enables the transmission of a communication signal to a receiver in another transceiver. The transceiver may be able to operate over multiple frequency ranges, typically referred to a frequency bands. Moreover, a single transceiver may be configured to operate using multiple carrier signals that may occur in the same frequency band, but that may not overlap in actual frequency, an arrangement referred to as non-contiguous carriers.

In some instances, it is desirable to have a single transmitter or receiver that is configured to operate using multiple transmit frequencies and/or multiple receive frequencies. For a receiver to be able to simultaneously receive two or more receive signals, the concurrent operation of two or more receive paths is generally required. Such systems are sometimes referred to as “carrier-aggregation” systems. The term “carrier-aggregation” may refer to systems that include inter-band carrier aggregation and intra-band carrier aggregation. Intra-band carrier aggregation refers to the processing of two separate carrier signals that occur in the same communication band. Inter-band carrier aggregation refers to the processing of two separate carrier signals that occur in different communication bands.

One of the challenges in receiving multiple signals in a receiver is preventing out of band (OOB) signals, referred to as “jammers” or “blockers” from interfering with the desired receive signals. Examples of OOB blockers include, for example, transmit energy from a nearby transmitter that can interfere with the receive signal due to the proximity of the transmit antenna to one or more receive antennas, and other blockers, such as wireless fidelity (WiFi) signals. One way of preventing OOB blockers from interfering with the desired receive signals is to implement a surface acoustic wave (SAW) filter. A SAW filter provides effective blocker rejection and a low insertion loss, but generally must be fabricated as a discrete component, and is not tunable. Accordingly, in a multi-band receiver the front-end is typically implemented using a number of band-select switches to direct the receive signal to the appropriate SAW filter. The SAW filter is then typically connected to a dedicated low noise amplifier (LNA). Typically, a matching network is also required between the SAW filter and the LNA to obtain good impedance matching.

In communication devices having many different communication bands, the origin and the intensity of a jammer signal may vary significantly depending on many factors. The insertion loss of a receive filter is associated with its signal rejection capability. Typically, a filter having a high signal rejection capability also has a high insertion loss. Therefore, it would be desirable to have a receive filter that can be adjusted to have the minimum desired signal rejection capability and the minimal insertion loss for a given signal rejection capability.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram showing a wireless device communicating with a wireless communication system.

FIG. 2A is a graphical diagram showing an example of contiguous intra-band carrier-aggregation (CA).

FIG. 2B is a graphical diagram showing an example of non-contiguous intra-band CA.

FIG. 2C is a graphical diagram showing an example of inter-band CA in the same band group.

FIG. 2D is a graphical diagram showing an example of inter-band CA in different band groups.

FIG. 3 is a block diagram showing a wireless device in which the exemplary techniques of the present disclosure may be implemented.

FIG. 4 is a schematic diagram illustrating an exemplary embodiment of a system having a tunable radio frequency (RF) front-end architecture.

FIG. 5 is a schematic diagram illustrating an exemplary embodiment of a tunable RF front-end module.

FIG. 6A is a schematic diagram illustrating an embodiment of a tunable filter.

FIG. 6B is a graphical illustration of an operating embodiment of the tunable filter of FIG. 6A.

FIG. 7A is a schematic diagram illustrating a first exemplary embodiment of a tunable notch resonator circuit.

FIG. 7B is a schematic diagram illustrating a second exemplary embodiment of a tunable notch resonator circuit.

FIG. 8A is a diagram illustrating an exemplary embodiment of a look up table that can be used in conjunction with the tunable notch resonator circuit of FIG. 7A.

FIG. 8B is a diagram illustrating an exemplary embodiment of a look up table that can be used in conjunction with the tunable notch resonator circuit of FIG. 7B.

FIG. 9A is a schematic diagram illustrating a first exemplary embodiment of a tunable bandpass resonator circuit.

FIG. 9B is a schematic diagram illustrating a second exemplary embodiment of a tunable bandpass resonator circuit.

FIG. 10A is a schematic diagram illustrating a first exemplary embodiment of a tunable trap resonator circuit.

FIG. 10B is a schematic diagram illustrating a second exemplary embodiment of a tunable trap resonator circuit.

FIG. 11 is a schematic diagram illustrating an exemplary embodiment of a tunable filter structure.

FIG. 12 is a flow chart describing an exemplary embodiment of a method for calibrating and tuning an adjustable filter.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

In an exemplary embodiment, the tunable radio frequency (RF) front-end architecture relates to an architecture for implementing a tunable RF front-end that provides band selection, unwanted signal rejection, and low insertion loss without using a surface acoustic wave (SAW) filter and matching circuitry for each receive band.

Exemplary embodiments of the disclosure are directed toward a calibration and tuning methodology for tuning an adjustable filter using two control signal inputs to provide desired signal rejection and minimal insertion loss.

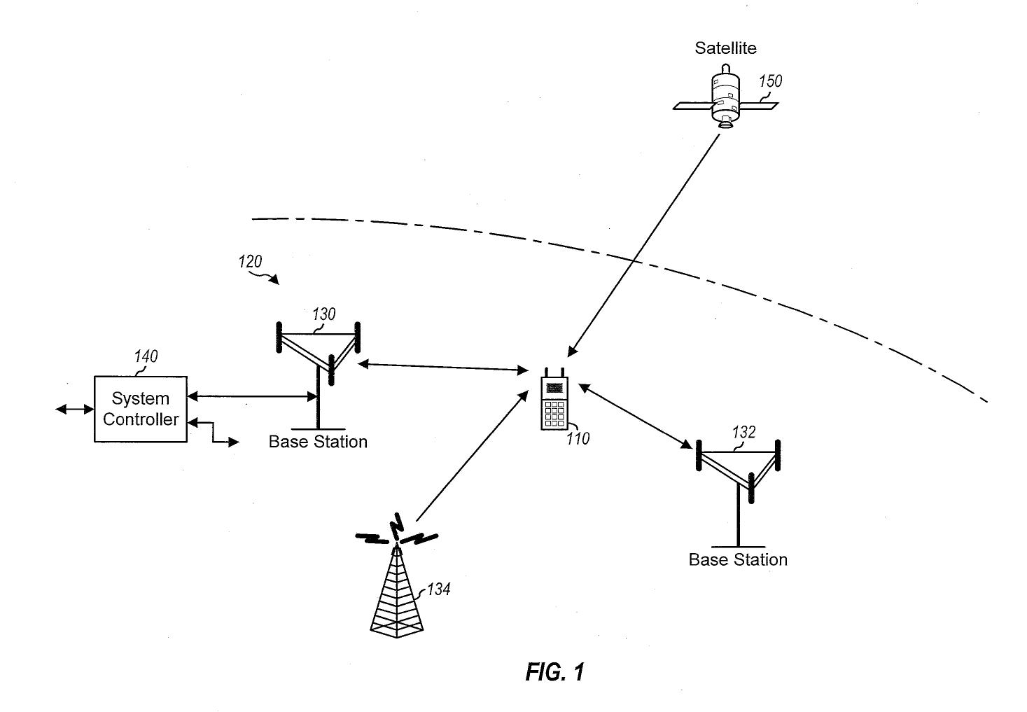

FIG. 1 is a diagram showing a wireless device 110 communicating with a wireless communication system 120. The wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless communication system may include any number of base stations and any set of network entities.

The wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a tablet, a cordless phone, a wireless local loop (WLL) station, a Bluetooth device, etc. Wireless device 110 may communicate with wireless communication system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1x, EVDO, TD-SCDMA, GSM, 802.11, etc.

Wireless device 110 may support carrier aggregation, which is operation on multiple carriers. Carrier aggregation may also be referred to as multi-carrier operation. Wireless device 110 may be able to operate in low-band (LB) covering frequencies lower than 1000 megahertz (MHz), mid-band (MB) covering frequencies from 1000 MHz to 2300 MHz, and/or high-band (HB) covering frequencies higher than 2300 MHz. For example, low-band may cover 698 to 960 MHz, mid-band may cover 1475 to 2170 MHz, and high-band may cover 2300 to 2690 MHz and 3400 to 3800 MHz. Low-band, mid-band, and high-band refer to three groups of bands (or band groups), with each band group including a number of frequency bands (or simply, “bands”). Each band may cover up to 200 MHz and may include one or more carriers. Each carrier may cover up to 20 MHz in LTE. LTE Release 11 supports 35 bands, which are referred to as LTE/UMTS bands and are listed in 3GPP TS 36.101. Wireless device 110 may be configured with up to five carriers in one or two bands in LTE Release 11.

In general, carrier aggregation (CA) may be categorized into two types—intra-band CA and inter-band CA. Intra-band CA refers to operation on multiple carriers within the same band. Inter-band CA refers to operation on multiple carriers in different bands.

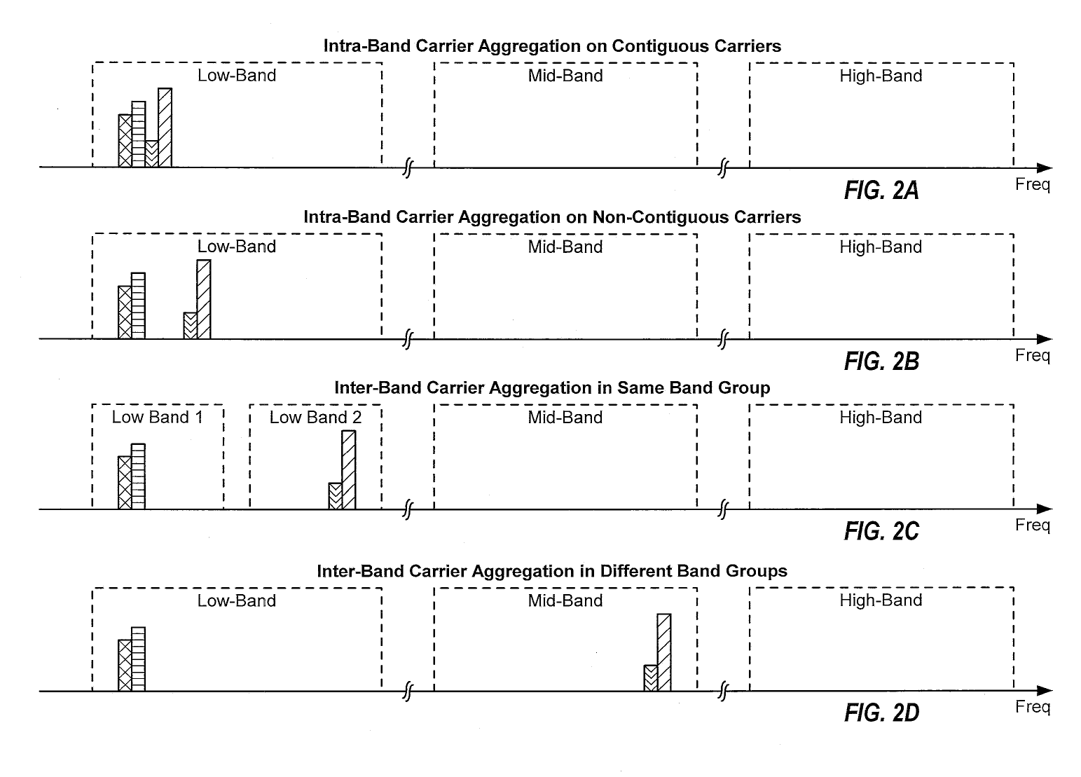

FIG. 2A is a graphical diagram showing an example of contiguous intra-band carrier-aggregation (CA). In the example shown in FIG. 2A, wireless device 110 is configured with four contiguous carriers in one band in low-band. Wireless device 110 may send and/or receive transmissions on the four contiguous carriers within the same band.

FIG. 2B is a graphical diagram showing an example of non-contiguous intra-band CA. In the example shown in FIG. 2B, wireless device 110 is configured with four non-contiguous carriers in one band in low-band. The carriers may be separated by 5 MHz, 10 MHz, or some other amount. Wireless device 110 may send and/or receive transmissions on the four non-contiguous carriers within the same band.

FIG. 2C is a graphical diagram showing an example of inter-band CA in the same band group. In the example shown in FIG. 2C, wireless device 110 is configured with four carriers in two bands in low-band. Wireless device 110 may send and/or receive transmissions on the four carriers in different bands in the same band group.

FIG. 2D is a graphical diagram showing an example of inter-band CA in different band groups. In the example shown in FIG. 2D, wireless device 110 is configured with four carriers in two bands in different band groups, which include two carriers in one band in low-band and two carriers in another band in mid-band. Wireless device 110 may send and/or receive transmissions on the four carriers in different bands in different band groups.

FIGS. 2A to 2D show four examples of carrier aggregation. Carrier aggregation may also be supported for other combinations of bands and band groups.

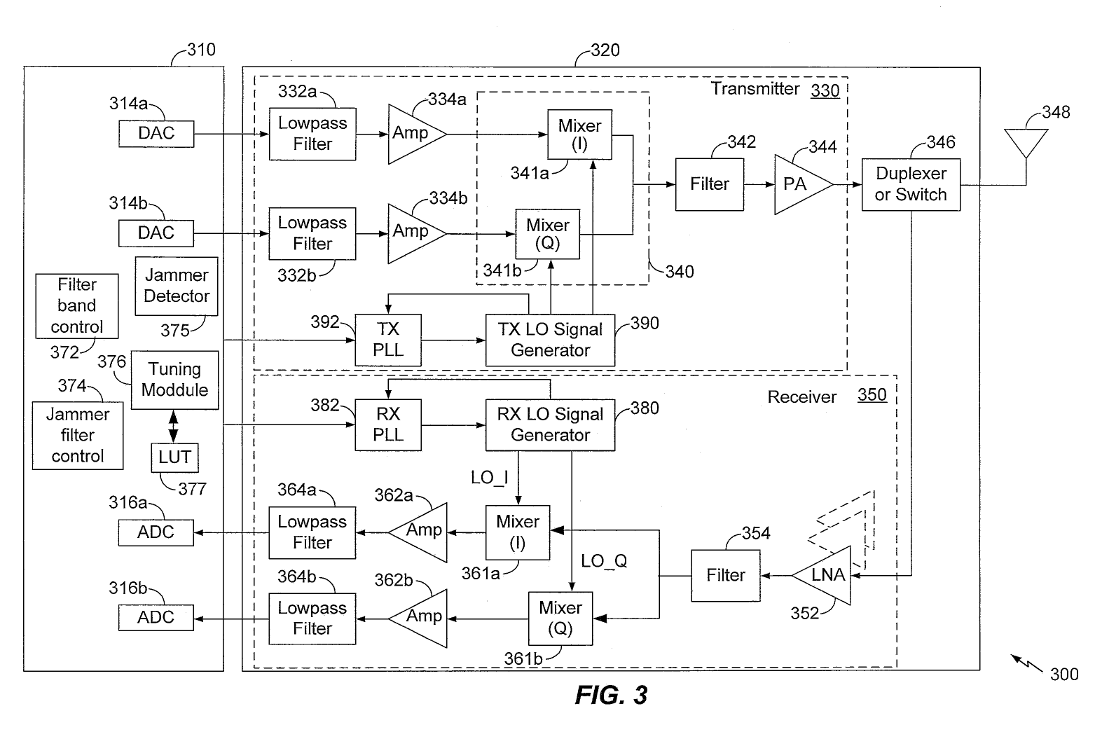

FIG. 3 is a block diagram showing a wireless device 300 in which the exemplary techniques of the present disclosure may be implemented. FIG. 3 shows an example of a transceiver 320. In general, the conditioning of the signals in a transmitter 330 and a receiver 350 may be performed by one or more stages of amplifier, filter, upconverter, downconverter, etc. These circuit blocks may be arranged differently from the configuration shown in FIG. 3. Furthermore, other circuit blocks not shown in FIG. 3 may also be used to condition the signals in the transmitter 330 and receiver 350. Unless otherwise noted, any signal in FIG. 3, or any other figure in the drawings, may be either single-ended or differential. Some circuit blocks in FIG. 3 may also be omitted.

In the example shown in FIG. 3, wireless device 300 generally comprises a transceiver 320 and a data processor 310. The data processor 310 may include a memory (not shown) to store data and program codes, and may generally comprise analog and digital processing elements. The transceiver 320 includes a transmitter 330 and a receiver 350 that support bi-directional communication. In general, wireless device 300 may include any number of transmitters and/or receivers for any number of communication systems and frequency bands. All or a portion of the transceiver 320 may be implemented on one or more analog integrated circuits (ICs), RF ICs (RFICs), mixed-signal ICs, etc.

A transmitter or a receiver may be implemented with a super-heterodyne architecture or a direct-conversion architecture. In the super-heterodyne architecture, a signal is frequency-converted between radio frequency (RF) and baseband in multiple stages, e.g., from RF to an intermediate frequency (IF) in one stage, and then from IF to baseband in another stage for a receiver. In the direct-conversion architecture, a signal is frequency converted between RF and baseband in one stage. The super-heterodyne and direct-conversion architectures may use different circuit blocks and/or have different requirements. In the example shown in FIG. 3, transmitter 330 and receiver 350 are implemented with the direct-conversion architecture.

In the transmit path, the data processor 310 processes data to be transmitted and provides in-phase (I) and quadrature (Q) analog output signals to the transmitter 330. In an exemplary embodiment, the data processor 310 includes digital-to-analog-converters (DAC's) 314a and 314b for converting digital signals generated by the data processor 310 into the I and Q analog output signals, e.g., I and Q output currents, for further processing.

Within the transmitter 330, lowpass filters 332a and 332b filter the I and Q analog transmit signals, respectively, to remove undesired images caused by the prior digital-to-analog conversion. Amplifiers (Amp) 334a and 334b amplify the signals from lowpass filters 332a and 332b, respectively, and provide I and Q baseband signals. An upconverter 340 upconverts the I and Q baseband signals with I and Q transmit (TX) local oscillator (LO) signals from a TX LO signal generator 390 and provides an upconverted signal. A filter 342 filters the upconverted signal to remove undesired images caused by the frequency upconversion as well as noise in a receive frequency band. A power amplifier (PA) 344 amplifies the signal from filter 342 to obtain the desired output power level and provides a transmit RF signal. The transmit RF signal is routed through a duplexer or switch 346 and transmitted via an antenna 348.

In the receive path, antenna 348 receives communication signals and provides a received RF signal, which is routed through duplexer or switch 346 and provided to a low noise amplifier (LNA) 352. The LNA 352 may comprise a single LNA configured to operate on one or more carrier signals, either stand-alone or simultaneously, or may comprise two or more LNAs configured to operate on one or more carrier signals, either stand-alone or simultaneously. The duplexer 346 is designed to operate with a specific RX-to-TX duplexer frequency separation, such that RX signals are isolated from TX signals. The received RF signal is amplified by LNA 352 and filtered by a filter 354 to obtain a desired RF input signal. Alternatively, the filter 354 may be located prior to the LNA 352, or may be located prior to the LNA 352 in addition to the filter 354.

In an exemplary embodiment, the data processor 310 comprises a filter band control circuit 372 and a jammer filter control circuit 374. The filter band control circuit 372 generates a first control signal that is used to tune the filter 354 to a desired receive frequency band. In an exemplary embodiment, the jammer filter control circuit 374 generates a second control signal that is used to further tune the filter 354 to optimize the filter's sensitivity and minimize the filter's insertion loss based on jammer signal power level. Jammer signal power and frequency is available from a jammer detection circuit 375 that can be located in the data processor 310. A tuning module 376 can be coupled to a look-up table 377 to develop the first control signal that is provided by the filter band control circuit 372 and the second control signal that is provided by the jammer filter control circuit 374.

Downconversion mixers 361a and 361b mix the output of filter 354 with I and Q receive (RX) LO signals (i.e., LO_I and LO_Q) from an RX LO signal generator 380 to generate I and Q baseband signals. The I and Q baseband signals are amplified by amplifiers 362a and 362b and further filtered by lowpass filters 364a and 364b to obtain I and Q analog input signals, which are provided to data processor 310. In the exemplary embodiment shown, the data processor 310 includes analog-to-digital-converters (ADC's) 316a and 316b for converting the analog input signals into digital signals to be further processed by the data processor 310.

In FIG. 3, TX LO signal generator 390 generates the I and Q TX LO signals used for frequency upconversion, while RX LO signal generator 380 generates the I and Q RX LO signals used for frequency downconversion. Each LO signal is a periodic signal with a particular fundamental frequency. A phase locked loop (PLL) 392 receives timing information from data processor 310 and generates a control signal used to adjust the frequency and/or phase of the TX LO signals from LO signal generator 390. Similarly, a PLL 382 receives timing information from data processor 310 and generates a control signal used to adjust the frequency and/or phase of the RX LO signals from LO signal generator 380.

Wireless device 300 may support CA and may (i) receive multiple downlink signals transmitted by one or more cells on multiple downlink carriers at different frequencies and/or (ii) transmit multiple uplink signals to one or more cells on multiple uplink carriers.

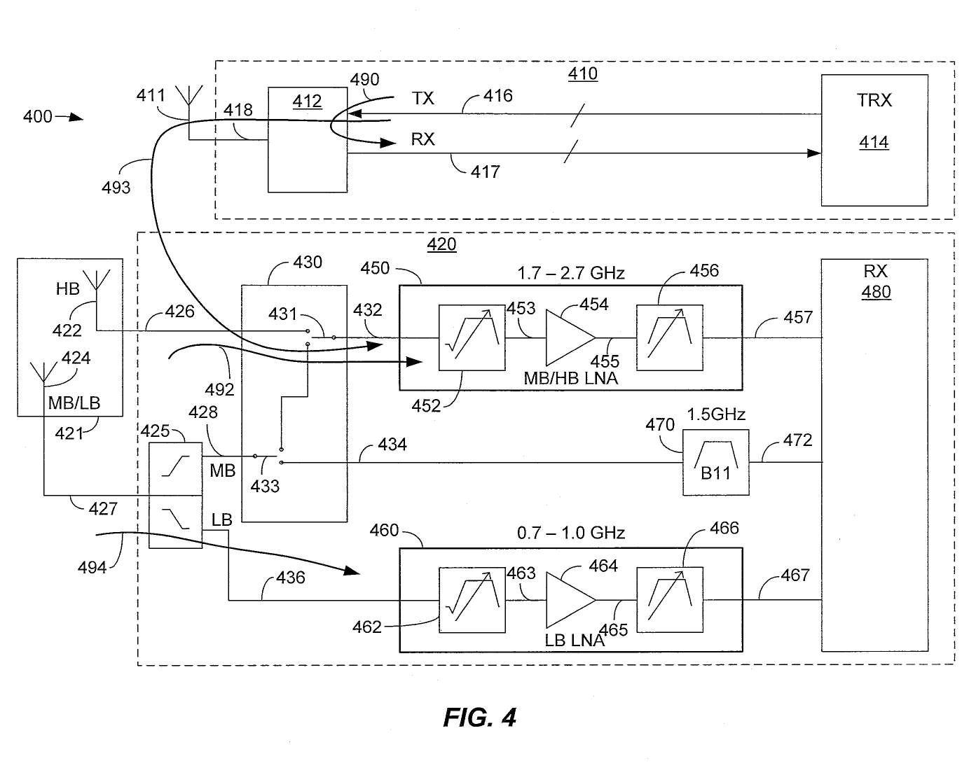

FIG. 4 is a schematic diagram illustrating an exemplary embodiment of a system 400 having a tunable radio frequency (RF) architecture. In an exemplary embodiment, the system 400 may be implemented as part of the transmitter 330 and the receiver 350 in the wireless device 300 of FIG. 3. The system 400 comprises a primary transceiver system 410 having a primary antenna 411, a duplexer 412 and a transceiver 414. The duplexer 412 is coupled to the transceiver 414 over transmit coupling 416 and receive coupling 417, each of which comprise multiple connections. The duplexer allows bi-directional (duplex) communication of transmit and receive signals over a single path 418 by isolating the transmit and receive signals.

The system 400 also comprises a secondary receiver system 420. In an exemplary embodiment, the secondary receiver system 420 comprises a diversity receiver comprising a dual feed antenna 421 (also referred to as a diversity antenna) a diplexer 425, a switch network 430, a first tunable RF front-end module 450, a second tunable RF front-end module 460, a filter 470 and a receiver 480. In an exemplary embodiment, the receiver 480 comprises downconversion, amplification, filtering and other circuitry. In an alternative exemplary embodiment, an embodiment of the first tunable RF front-end module 450 and/or the second tunable RF front-end module 460 can be implemented in a diversity receiver in a TDD or half-duplex FDD system.

In an exemplary embodiment, the dual feed antenna 421 comprises a first antenna 422 and a second antenna 424. In an exemplary embodiment, the first antenna 422 can be configured to process a radio frequency (RF) signal in what is referred to as a “high band” (HB). In an exemplary embodiment, the second antenna 424 can be configured to process a radio frequency (RF) signal in what is referred to as a “mid band” (MB) and “low band” (LB). More than two antennas can be implemented in a diversity antenna system, with two antennas being illustrated for simplicity.

The first antenna 422 is coupled to the switch network 430 over connection 426 and the second antenna 424 is coupled to the diplexer 425 over connection 427. The switch network 430 comprises a first switch 431 and a second switch 433. The first antenna 422 provides a high-band RF signal over connection 426 to the first switch 431. The diplexer 425 is connected to the second switch 433 over connection 428. The diplexer 425 is connected to the second tunable RF front-end module 460 over connection 436. The diplexer provides a mid-band RF signal to the switch 433 over connection 428 and provides a low band RF signal to the second tunable RF front-end module 460 over connection 436.

In an exemplary embodiment, in a first position, the first switch 431 can be configured to deliver the high-band RF signal to the first tunable RF front-end module 450 over connection 432.

In an exemplary embodiment, the first switch 431 and the second switch 433 can be configured to deliver the mid-band RF signal from the diplexer 425 to the first tunable RF front-end module 450; and can also be configured to deliver the mid-band RF signal from the diplexer 425 to the filter 470 over connection 434. In an exemplary embodiment, the filter 470 can be configured to pass a RF signal in the 1.5 GHz frequency band over connection 472 to the receiver 480. The switches 431 and 433 can be controlled by control logic (not shown) associated with the transceiver 480.

The first tunable RF front-end module 450 comprises a first tunable filter 452 coupled to a low noise amplifier (LNA) 454 over connection 453. The LNA 454 is coupled to a second tunable filter 456 over connection 455. The output of the second tunable filter 456 is provided to the receiver 480 over connection 457. The second tunable RF front-end module 460 comprises a first tunable filter 462 coupled to a low noise amplifier (LNA) 464 over connection 463. The LNA 464 is coupled to a second tunable filter 466 over connection 465. The output of the second tunable filter 466 is provided to the receiver 480 over connection 467.

In an exemplary embodiment, the first tunable RF front-end module 450 can be configured to process an RF signal in the high-band and in the mid-band, comprising a frequency range of approximately 1.7-2.7 GHz. In an exemplary embodiment, the second tunable RF front-end module 460 can be configured to process an RF signal in the low-band comprising a frequency range of approximately 0.7-1.0 GHz.

Many jammer scenarios exist in modern mobile technologies. In frequency division duplexing (FDD) systems, a TX jammer can leak into the receiver through finite duplexer isolation and antenna isolation. For example, a TX jammer 490 can leak through the duplexer 412 and interfere with a signal on connection 417. In another example, a WIFI transmitting signal 492 can also leak into a cellular receiver through finite antenna isolation, a TX jammer 493 from a primary transceiver system 410 can leak into a receive path in a secondary receiver system 420, or a continuous wave (CW jammer 494 could leak into a receive path through, for example, the diplexer 425. In addition, standards dictate that a receiver should be able to handle an adjacent single-tone jammer with certain power levels. In order to obtain sufficient jammer rejection, current duplexer/diversity filters trade off insertion loss for better jammer rejection. This is especially true for FDD bands with small duplex frequency separations, where large in-band insertion loss is used to provide sufficient TX signal rejection. However, in practice, the power level of the TX jammer as well as WIFI and adjacent single-tone jammer signals vary significantly. This implies that for lower TX/WIFI/adjacent single-tone jammer levels, less jammer rejection, and therefore, less in-band insertion loss is possible for a receiver filter. In accordance with an exemplary embodiment, dynamic tuning of a receiver filter according to the power level of the jammer signal is provided.

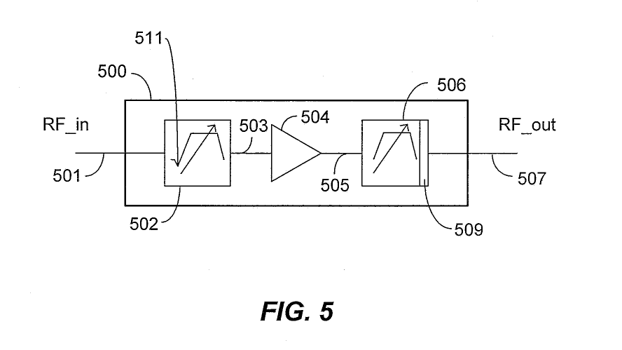

FIG. 5 is a schematic diagram illustrating an exemplary embodiment of a tunable RF front-end module having one or more tunable filters. The tunable RF front-end module 500 comprises a first tunable filter 502 configured to receive a radio frequency input signal, RF_in, over connection 501. The RF_in signal on connection 501 can comprise a signal in any of the communication bands mentioned herein. The first tunable filter 502 is coupled to a low noise amplifier (LNA) 504 over connection 503. The LNA 504 is coupled to a second tunable filter 506 over connection 505. The output of the second tunable filter 506 is a radio frequency output signal, RF_out, and is provided over connection 507. In an exemplary embodiment, the second tunable filter 506 may comprise a matching network 509 configured to provide impedance matching between the tunable RF front-end module 500 and a downstream element coupled over connection 507.

In an exemplary embodiment, at least some of the characteristics of the first tunable filter 502 may be different than at least some of the characteristics of the second tunable filter 506. For example, the first tunable filter 502 may be configured to provide a first portion of the overall desired signal rejection, while having a first insertion loss, and the second tunable filter 506 can be configured to provide a second portion of the overall desired signal rejection, while having a second insertion loss. The LNA 504 can be configured to amplify the frequency selective signal provided by the first tunable filter 502 to compensate for any insertion loss introduced by the first tunable filter 502 and the second tunable filter 506. The second tunable filter 506 provides a second frequency selective signal as an RF_out signal on connection 507. The signal rejection provided by the first tunable filter 502 may be greater than or less than the signal rejection provided by the second tunable filter 506. The insertion loss introduced by the first tunable filter 502 may be greater than or less than the insertion loss introduced by the second tunable filter 506. In an exemplary embodiment, the first tunable filter 502 and the second tunable filter 506 may be controlled by one or more control signals from the filter band control circuit 372 and the jammer filter control circuit 374 of FIG. 3, or from another control device (not shown).

In an exemplary embodiment, any of the first tunable filter 502 and the second tunable filter 506 may also provide a bandpass filter response for rejecting a signal that may occur at a frequency other than a frequency band of the desired receive signal. In an exemplary embodiment, the first tunable filter 502 may be designed to have a notch 511, or other filter characteristic, such as one or more bandpass filter characteristics, one or more trap characteristics, or other filter characteristics adapted to filter a signal occurring at a frequency other than the frequency band of the desired receive signal. In an exemplary embodiment, the first tunable filter 502 may include a notch 511, or other filter characteristic adapted to filter a signal occurring at a transmit frequency of the primary transceiver system 410 (FIG. 4) and which may be coupled from the primary antenna 411 (FIG. 4) to the dual feed antenna 421 (FIG. 4).

In an exemplary embodiment, the first tunable filter 502 may be configured to reject one or more blockers. For example, the first tunable filter 502 may be configured to reject a transmit blocker and a WiFi blocker, or the first tunable filter 502 may be configured to reject a transmit blocker and another OOB jammer. In an exemplary embodiment, the second tunable filter 506 can reject only a transmit blocker or only a WiFi blocker. In an exemplary embodiment, the capabilities of the first tunable filter 502 and the second tunable filter 506 may be interchanged.

In an exemplary embodiment, the first tunable filter 502 and the second tunable filter 506 can be implemented using an inductive-capacitive (LC) filter network and the LNA can be implemented using transistors fabricated according to one or more technologies, including, for example, field-effect-transistor (FET) technology. An exemplary process for fabricating the transistors and the capacitances is referred to as silicon on insulator (SOI) technology. The inductances in the LC network can be high-quality factor (high-Q) inductances which can be fabricated on the laminate structure on which the SOI chip can be assembled into a circuit package.

In an exemplary embodiment, the first tunable filter 502 and the second tunable filter 506 can be configured to provide the desired band filtering and frequency selection, with sufficient blocker rejection, and an acceptable insertion loss, such that a receiver using the tunable RF front-end module 500 can be implemented without using a SAW filter for band selection and signal rejection, and without an associated matching network for each SAW filter.

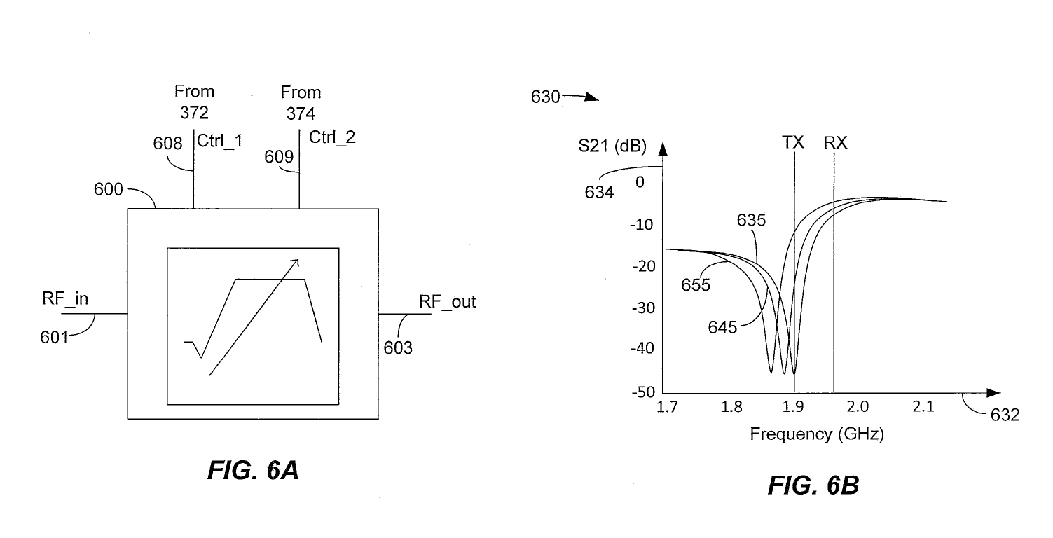

FIG. 6A is a schematic diagram illustrating an embodiment of a tunable filter 600. The tunable filter 600 can be an exemplary embodiment of any of the tunable filters 502 and/or 506 described in FIG. 5. In an exemplary embodiment, the tunable filter 600 can be an exemplary implementation of the tunable filter 502 having one or more filter characteristics, such as, for example, one or more of a notch characteristic, a bandpass characteristic and a trap characteristic. In an exemplary embodiment, a radio frequency (RF) input signal is provided to the tunable filter 600 over connection 601 and a RF output signal is generated over connection 603. A first tuning input, Ctr1_1, comprising a first tuning signal from the filter band control circuit 372 is provided over connection 608. In an exemplary embodiment, a second tuning input, Ctr1_2, comprising a second tuning signal from the jammer filter control circuit 374 is provided over connection 609. The filter band control circuit 372 and the jammer filter control circuit 374 can be part of a control system that generates the first tuning input, Ctr1_1 and the second tuning input, Ctr1_2.

The first tuning input, Ctr1_1, determines the selected frequency band and channel to which the tunable filter 600 will be initially tuned. The first control signal, Ctr1_1, determines the appropriate filter response shape for a specific frequency channel and ensures that the tunable filter is tuned to the desired frequency band.

The second tuning input, Ctr1_2, comprises a control signal related to the power level of a jammer signal. The second control signal, Ctr1_2, performs filter response fine tuning based on the filter response shape determined by the first control signal, Ctr1_1. The second control signal, Ctr1_2, ensures that the receiver sensitivity is optimal under various jammer power levels by modifying the response of the tunable filter to provide the desired signal rejection while minimizing the insertion loss based on the actual jammer power level.

FIG. 6B is a graphical illustration showing an exemplary operating embodiment of the tunable filter of FIG. 6A. The horizontal axis 632 shows frequency in GHz and the vertical axis 634 shows insertion loss (IL) as a function of S21 in dB. The Insertion Loss is defined as 10*log (Po/Pi) where Po is output power and Pi is input power. In the example shown, the desired receive band filter response is chosen by the first control signal, Ctr1_1 as the FDD Band 2, with uplink frequencies spanning 1.85 to 1.91 GHz and downlink frequencies spanning 1.93 to 1.99 GHz. The center of an exemplary transmit band is shown at approximately 1.9 GHz and the center of an exemplary receive band is shown at approximately 1.97 GHz. The second control signal, Ctr1_2, is based on the power level of a detected jammer signal. In an exemplary embodiment, the control signal Ctr1_2 can vary the response of the tunable filter 600 responsive to received jammer signals and in an exemplary embodiment is shown as being responsive to jammer signals having power levels of 0 dBm, 10 dBm and 23 dBm. The trace 635 illustrates a notch filter characteristic based on a second control signal, Ctr1_2, responsive to a jammer signal having a power of 23 dBm and shows a TX notch located at 1.9 GHz. The trace 645 illustrates a notch filter characteristic based on a second control signal, Ctr1_2, responsive to a jammer signal having a power of 10 dBm and shows a TX notch located at a frequency lower than 1.9 GHz with an improvement in insertion loss relative to the trace 635. The trace 655 illustrates a notch filter characteristic based on a second control signal, Ctr1_2, responsive to a jammer signal having a power of 0 dBm and shows the TX notch at a frequency lower than the notch of the trace 645, with an improvement in insertion loss relative to the trace 645. The exact TX notch frequency is determined based on the jammer power level. The TX notch depth and in band insertion loss is a trade off. For example, when the TX jammer power level is strong, it is desirable to locate the TX notch close to or at the transmit frequency to obtain maximum TX jammer rejection. This is illustrated in the trace 635 where the notch is located at the example TX frequency of 1.9 GHz in the presence of the strong 23 dBm jammer. However, when the TX jammer power level is low, the TX notch can be shifted away from the TX frequency in order to improve the insertion loss, as shown in trace 645 with a 10 dBm TX jammer and in trace 655 with a 0 dBm TX jammer.

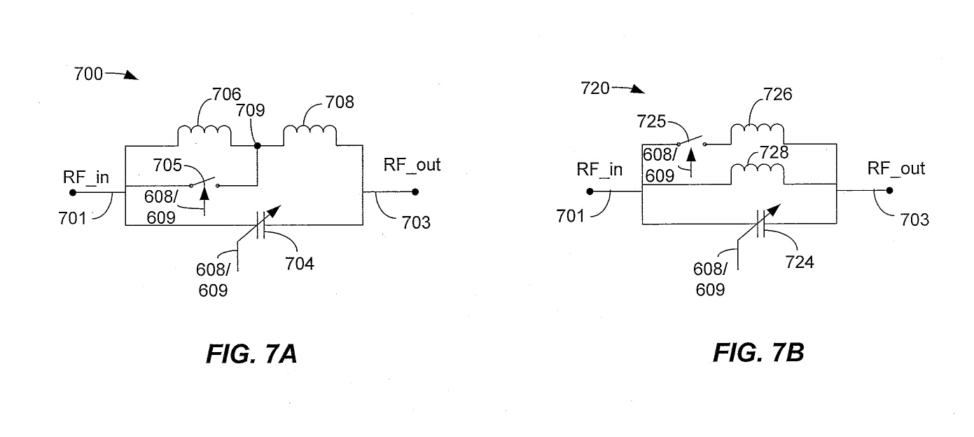

FIG. 7A is a schematic diagram illustrating a first exemplary embodiment of a tunable notch resonator circuit that can be implemented in the tunable filter 600. The tunable notch resonator circuit 700 comprises an adjustable capacitance 704, and inductances 706 and 708, which are coupled in series. The RF input signal, RF_in, is provided over connection 701 and the RF output signal, RF_out, is provided over connection 703. A switch 705 is coupled between the RF input signal on connection 701 and the node 709 between the inductances 706 and 708. The node 709 forms a tap between the inductances 706 and 708.

The tunable notch resonator circuit 700 is an example of using a “series-coupled” switch 705 that can controlled by the control signals, Cctr1_1 and Ctr1_2, over connections 608 and 609 to determine the value of the inductance presented to the RF_in signal. The tunable capacitance 704 is also controlled by the control signals, Cctr1_1 and Ctr1_2, over connections 608 and 609 to determine the value of the capacitance presented to the RF_in signal.

In the exemplary embodiment shown in FIG. 7A, when the switch 705 is open, the inductance presented to the input signal on connection 701 comprises the value of the inductances 706 and 708. However, when the switch 705 is closed, the inductance presented to the input signal on connection 701 comprises the value of the inductance 708 only. In this manner, the total inductance provided by the tunable notch resonator circuit 700 may be adjusted, thereby adjusting the resonant frequency of the tunable notch resonator circuit 700. In an embodiment, the values of the inductances 706 and 708 may be the same, or substantially similar, whereby the inductance at the node 709 represents substantially one half of the total inductance, and the inductances 706 and 708 would be referred to as “center tapped” when the switch 705 is closed. In alternative embodiments, the values of the inductances 706 and 708 may be different, whereby the inductance at the node 709 represents less than or more than one half of the total inductance, and the inductances 706 and 708 would be referred to as “non-center tapped” when the switch 705 is closed. In any embodiment, the values of the inductances 706 and 708 may be selected to determine the resonant frequency of the tunable notch resonator circuit 700 both with the switch 705 open and the switch 705 closed. In this manner, the transmission poles and zeros of the tunable notch resonator circuit 700 can be adjusted.

FIG. 7B is a schematic diagram illustrating a second exemplary embodiment of a tunable notch resonator circuit. The tunable notch resonator circuit 720 comprises an adjustable capacitance 724, and inductances 726 and 728, which are coupled in parallel. The RF input signal, RF_in, is provided over connection 701 and the RF output signal, RF_out, is provided over connection 703. A switch 725 is coupled to one side of the inductance 726. The other side of the switch 725 is coupled to the input signal on connection 701.

The tunable notch resonator circuit 720 is an example of using a “parallel-coupled” switch 725 that is controlled by the control signals, Cctr1_1 and Ctr1_2, over connections 608 and 609 to determine the value of the inductance presented to the RF_in signal. The tunable capacitance 724 is also controlled by the control signals, Cctr1_1 and Ctr1_2, over connections 608 and 609 to determine the value of the capacitance presented to the RF_in signal.

In the exemplary embodiment shown in FIG. 7B, when the switch 725 is open, the inductance presented to the input signal on connection 701 comprises the value of the inductance 728 alone. However, when the switch 725 is closed, the inductance presented to the input signal on connection 701 comprises the value of the inductance 728 and the value of the inductance 726. In this manner, the total inductance provided by the tunable notch resonator circuit 720 may be adjusted, thereby adjusting the resonant frequency of the tunable notch resonator circuit 720. In an embodiment, the values of the inductances 726 and 728 may be the same, or substantially similar, whereby the inductance at the RF_in connection 701 with the switch 725 open may comprise substantially one half of the total inductance. In alternative embodiments, the values of the inductances 726 and 728 may be different, whereby the inductance with the switch 725 open may present less than or more than one half of the total inductance to the input connection 701. In any embodiment, the values of the inductances 726 and 728 may be selected to determine the resonant frequency of the tunable notch resonator circuit 720 both with the switch 725 open and the switch 725 closed. In this manner, the transmission poles and zeros of the tunable notch resonator circuit 720 can be adjusted.

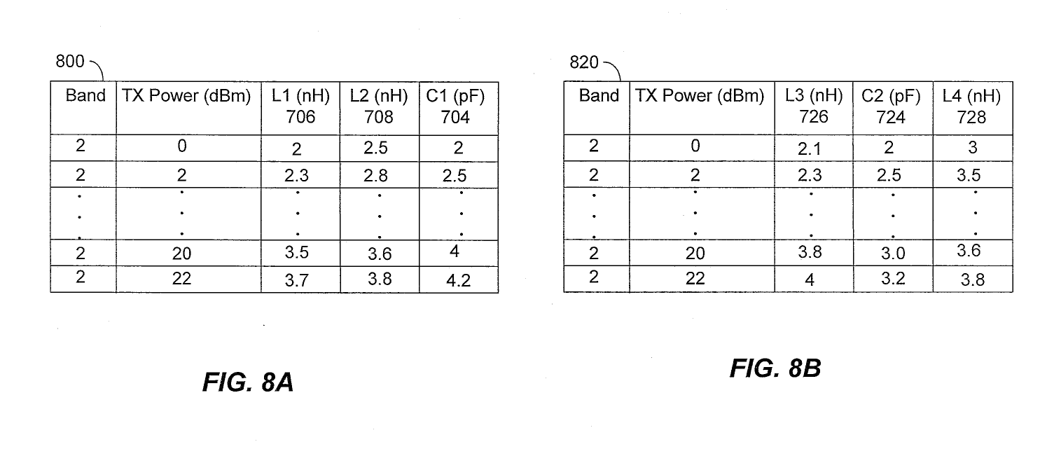

FIG. 8A is a diagram illustrating an exemplary embodiment of a look up table 800 that can be used in conjunction with the tunable notch resonator circuit 700 of FIG. 7A. In an exemplary embodiment the look up table 800 can be an example of the look up table 377 in the wireless device 300.

In an exemplary embodiment using the filter of FIG. 7A, the look up table 800 can be created by determining the optimal values of the inductors and capacitors based on desired frequency and on jammer power level. For example, the variable inductors and capacitors have a range of values, e.g., inductor 706 can range from 1-5 nH, inductor 708 can range from 1-5 nH, and capacitor 704 may range from 1-10 pF. In the presence of a jammer (for example, a TX jammer having a power level of 22 dBm at the antenna output), the inductor 706 is swept through its range of values from 1 nH to 5 nH at an exemplary step size of 0.2 nH, the inductor 708 is swept through its range of values from 1 nH to 5 nH at an exemplary step size of 0.2 nH, and the capacitor 704 is swept through its range of values from 1 pF to 10 pF at an exemplary step size of 0.2 pF. For each swept combination, a receive automatic gain control (RxAGC) value is obtained from the data processor 310. The combination of values for the inductors 706 and 708, and the capacitance 704 that provides the smallest RxAGC reading corresponds to the optimal inductor and capacitor values corresponding to the Tx jammer at the exemplary power of 22 dBm. These values are used to populate the look up table 800 for a 22 dBm jammer. This is repeated for each jammer power level.

In an exemplary embodiment the look up table 800 comprises information relating to the calibration of a wireless device implementing the notch resonator 700 of FIG. 7A. The exemplary embodiment of the look up table 800 relates to operation in LTE Band 2 and shows transmit power (TX Power) in dBm ranging from 0 dBm to 22 dBm, and includes entries for the values of the inductance 706 (L1) in nH, entries for the inductance 708 (L2) in nH, and entries for the capacitance 704 (C1) in pF. For example, at a TX power of 0 dBm, the value of the inductance 706 would be set to 2 nH, the value of the inductance 708 would be set to 2.5 nH and the value of the capacitance 704 would be set to 2 pF. Similarly, for a TX power of 2 dBm, the value of the inductance 706 would be set to 2 nH, the value of the inductance 708 would be set to 2.8 nH and the value of the capacitance 704 would be set to 2.5 pF. In this exemplary embodiment, values for TX Power in 2 dBm increments up to an exemplary power level of 22 dBm are set.

In an exemplary operational embodiment, assume that the wireless device is controlled to develop a TX Power of 21 dBm. This can create a 21 dBm TX jammer at the antenna output into the receive band. As the TX jammer power level changes, the location of the notch in the filter response is shifted by changing the variable inductance and capacitance values. Using FIG. 7A as an example, the tuning module 376 queries the look up table 800 to determine the values of the inductances 706 and 708 and the value of the capacitance 704 that corresponds to the subject TX power level of 21 dBm in this example. In this exemplary embodiment, the subject TX Power of 21 dBm does not correspond to a direct entry in the look up table 800, so the tuning module 376 interpolates the values of the inductances 706 and 708 and the value of the capacitance 704 between 20 dBm and 22 dBm, resulting in the exemplary values of 3.6 nH for the inductance 706, 3.7 nH for the inductance 708 and 4.1 pF for the capacitance 704. These values are set by the first tuning input, Ctr1_1, comprising the first tuning signal from the filter band control circuit 372 over connection 608 and by the second tuning input, Ctr1_2, comprising the second tuning signal from the jammer filter control circuit 374 over connection 609.

FIG. 8B is a diagram illustrating an exemplary embodiment of a look up table 820 that can be used in conjunction with the tunable notch resonator circuit 720 of FIG. 7B. In an exemplary embodiment the look up table 820 can be an example of the look up table 377 in the wireless device 300. In an exemplary embodiment the look up table 820 comprises information relating to the calibration of a wireless device implementing the notch resonator 720 of FIG. 7B. The exemplary embodiment of the look up table 820 relates to operation in LTE Band 2 and shows transmit power (TX Power) in dBm ranging from 0 dBm to 22 dBm, and includes entries for the values of the inductance 726 (L3) in nH, entries for the inductance 728 (L4) in nH, and entries for the capacitance 724 (C2) in pF. For example, at a TX power of 0 dBm, the value of the inductance 726 would be set to 2.1 nH, the value of the inductance 728 would be set to 3 nH and the value of the capacitance 724 would be set to 2 pF. Similarly, for a TX power of 2 dBm, the value of the inductance 726 would be set to 2.5 nH, the value of the inductance 728 would be set to 3.5 nH and the value of the capacitance 724 would be set to 2.5 pF. In this exemplary embodiment, values for TX Power in 2 dBm increments up to an exemplary power level of 22 dBm are set.

In an exemplary operational embodiment, assume that the wireless device is controlled to develop a TX Power of 21 dBm. The tuning module 376 would query the look up table 820 to determine the values of the inductances 726 and 728 and the value of the capacitance 724 that corresponds to the TX power level of 21 dBm in this example. In this exemplary embodiment, the TX Power of 21 dBm does not correspond to a direct entry in the look up table 820, so the tuning module 376 interpolates the values of the inductances 726 and 728 and the value of the capacitance 724 between 20 dBm and 22 dBm, resulting in the values of 3.9 nH for the inductance 726, 3.7 nH for the inductance 728 and 3.1 pF for the capacitance 724. These values are set by the first tuning input, Ctr1_1, comprising the first tuning signal from the filter band control circuit 372 over connection 608 and by the second tuning input, Ctr1_2, comprising the second tuning signal from the jammer filter control circuit 374 over connection 609.

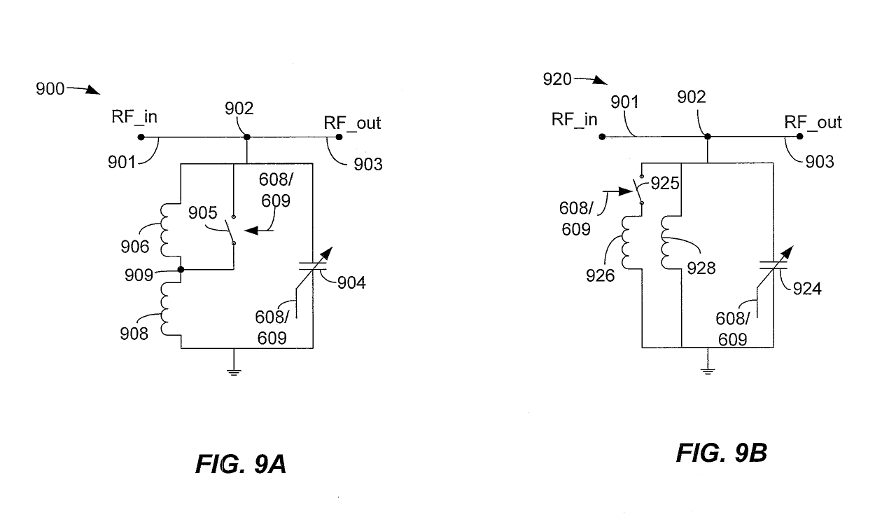

FIG. 9A is a schematic diagram illustrating a first exemplary embodiment of a tunable bandpass resonator circuit. The tunable notch bandpass circuit 900 comprises an adjustable capacitance 904, and inductances 906 and 908, which are coupled in series. The RF input signal, RF_in, is provided over connection 901 and the RF output signal, RF_out, is provided over connection 903. A switch 905 is coupled between the node 902 between the input signal on connection 901 and the output signal on connection 903, and the node 909 between the inductances 906 and 908. The node 909 forms a tap between the inductances 906 and 908.

The tunable bandpass resonator circuit 900 is an example of using a “series-coupled” switch 905 that is controlled by the control signals, Cctr1_1 and Ctr1_2, over connections 608 and 609 to determine the value of the inductance presented to the RF_in signal. The tunable capacitance 904 is also controlled by the control signals, Cctr1_1 and Ctr1_2, over connections 608 and 609 to determine the value of the capacitance presented to the signal at node 902.

In the exemplary embodiment shown in FIG. 9A, when the switch 905 is open, the inductance presented to the input signal on node 902 comprises the value of the inductances 906 and 908. However, when the switch 905 is closed, the inductance presented to the input signal on the node 902 comprises the value of the inductance 908 only. In this manner, the total inductance provided by the tunable bandpass resonator circuit 900 may be adjusted, thereby adjusting the resonant frequency of the tunable notch bandpass circuit 900. In an embodiment, the values of the inductances 906 and 908 may be the same, or substantially similar, whereby the inductance at the node 909 represents substantially one half of the total inductance, and the inductances 906 and 908 would be referred to as “center tapped” when the switch 905 is closed. In alternative embodiments, the values of the inductances 906 and 908 may be different, whereby the inductance at the node 909 represents less than or more than one half of the total inductance, and the inductances 906 and 908 would be referred to as “non-center tapped” when the switch 905 is closed. In any embodiment, the values of the inductances 906 and 908 may be selected to determine the resonant frequency of the tunable bandpass resonator circuit 900 both with the switch 905 open and the switch 905 closed. In this manner, the transmission poles and zeros of the tunable bandpass resonator circuit 900 can be adjusted.

FIG. 9B is a schematic diagram illustrating a second exemplary embodiment of a tunable bandpass resonator circuit. The tunable bandpass resonator circuit 920 comprises an adjustable capacitance 924, and inductances 926 and 928, which are coupled in parallel. The RF input signal, RF_in, is provided over connection 901 and the RF output signal, RF_out, is provided over connection 903. A switch 925 is coupled to one side of the inductance 926. The other side of the switch 925 is coupled to the node 902 between the RF input signal on connection 901 and the RF output signal on connection 903.

The tunable bandpass resonator circuit 920 is an example of using a “parallel-coupled” switch 925 that is controlled by the control signals, Cctr1_1 and Ctr1_2, over connections 608 and 609 to determine the value of the inductance presented to the signal at node 902. The tunable capacitance 924 is also controlled by the control signals, Cctr1_1 and Ctr1_2, over connections 608 and 609 to determine the value of the capacitance presented to the signal at node 902.

In the exemplary embodiment shown in FIG. 9B, when the switch 925 is open, the inductance presented to the signal on node 902 comprises the value of the inductance 928 alone. However, when the switch 925 is closed, the inductance presented to the signal on node 902 comprises the value of the inductance 928 and the value of the inductance 926. In this manner, the total inductance provided by the tunable bandpass resonator circuit 920 may be adjusted, thereby adjusting the resonant frequency of the tunable bandpass resonator circuit 920. In an embodiment, the values of the inductances 926 and 928 may be the same, or substantially similar, whereby the inductance at the node 902 with the switch 925 open may comprise substantially one half of the total inductance. In alternative embodiments, the values of the inductances 926 and 928 may be different, whereby the inductance with the switch 925 open may present less than or more than one half of the total inductance to the signal on node 902. In any embodiment, the values of the inductances 926 and 928 may be selected to determine the resonant frequency of the tunable bandpass resonator circuit 920 both with the switch 925 open and the switch 925 closed. In this manner, the transmission poles and zeros of the tunable notch resonator circuit 920 can be adjusted.

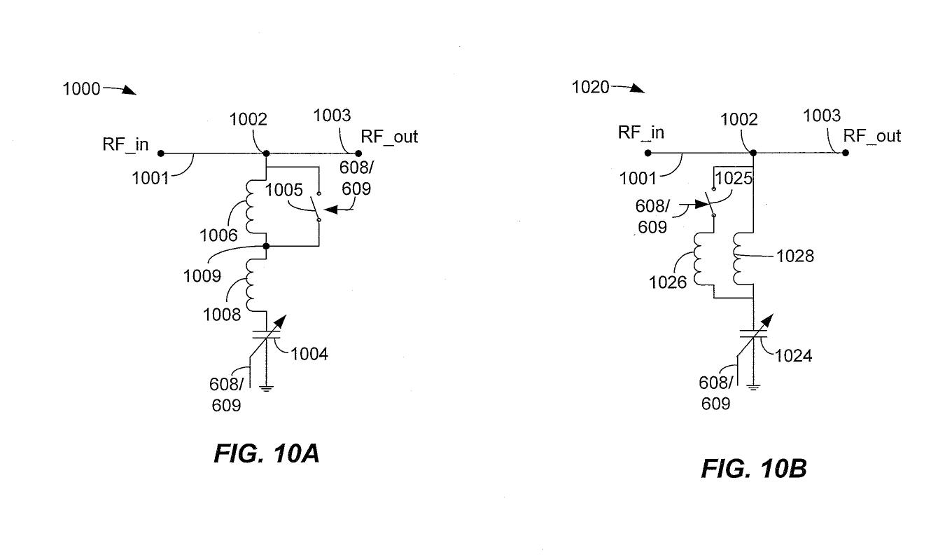

FIG. 10A is a schematic diagram illustrating a first exemplary embodiment of a tunable trap resonator circuit. The tunable trap resonator circuit 1000 comprises an adjustable capacitance 1004, and inductances 1006 and 1008, which are coupled in series. The RF input signal, RF_in, is provided over connection 1001 and the RF output signal, RF_out, is provided over connection 1003. A switch 1005 is coupled to the node 1002 between the RF input signal on connection 1001 and the RF output signal on connection 1003, and the node 1009 between the inductances 1006 and 1008. The node 1009 forms a tap between the inductances 1006 and 1008.

The tunable trap resonator circuit 1000 is an example of using a “series-coupled” switch 1005 that is controlled by the control signals, Cctr1_1 and Ctr1_2, over connections 608 and 609 to determine the value of the inductance presented to the signal at node 1002. The tunable capacitance 1004 is also controlled by the control signals, Cctr1_1 and Ctr1_2, over connections 608 and 609 to determine the value of the capacitance presented to the signal at node 1002.

In the exemplary embodiment shown in FIG. 10A, when the switch 1005 is open, the inductance presented to the signal on node 1002 comprises the value of the inductances 1006 and 1008. However, when the switch 1005 is closed, the inductance presented to the signal on node 1002 comprises the value of the inductance 1008 only. In this manner, the total inductance provided by the tunable trap resonator circuit 1000 may be adjusted, thereby adjusting the resonant frequency of the tunable trap resonator circuit 1000. In an embodiment, the values of the inductances 1006 and 1008 may be the same, or substantially similar, whereby the inductance at the node 1009 represents substantially one half of the total inductance, and the inductances 1006 and 1008 would be referred to as “center tapped” when the switch 1005 is closed. In alternative embodiments, the values of the inductances 1006 and 1008 may be different, whereby the inductance at the node 1009 represents less than or more than one half of the total inductance, and the inductances 1006 and 1008 would be referred to as “non-center tapped” when the switch 1005 is closed. In any embodiment, the values of the inductances 1006 and 1008 may be selected to determine the resonant frequency of the tunable trap resonator circuit 1000 both with the switch 1005 open and the switch 1005 closed. In this manner, the transmission poles and zeros of the tunable trap resonator circuit 1000 can be adjusted.

FIG. 10B is a schematic diagram illustrating a second exemplary embodiment of a tunable trap resonator circuit. The tunable trap resonator circuit 1020 comprises an adjustable capacitance 1024, and inductances 1026 and 1028, which are coupled in parallel. The RF input signal, RF_in, is provided over connection 1001 and the RF output signal, RF_out, is provided over connection 1003. A switch 1025 is coupled to one side of the inductance 1026. The other side of the switch 1025 is coupled to the node 1002 between the RF input signal on connection 1001 and the RF output signal on connection 1003.

The tunable trap resonator circuit 1020 is an example of using a “parallel-coupled” switch 1025 that is controlled by the control signals, Cctr1_1 and Ctr1_2, over connections 608 and 609 to determine the value of the inductance presented to the signal at node 1002. The tunable capacitance 1024 is also controlled by the control signals, Cctr1_1 and Ctr1_2, over connections 608 and 609 to determine the value of the capacitance presented to the signal at node 1002.

In the exemplary embodiment shown in FIG. 10B, when the switch 1025 is open, the inductance presented to the signal on node 1002 comprises the value of the inductance 1028 alone. However, when the switch 1025 is closed, the inductance presented to the signal on node 1002 comprises the value of the inductance 1028 and the value of the inductance 1026. In this manner, the total inductance provided by the tunable trap resonator circuit 1020 may be adjusted, thereby adjusting the resonant frequency of the tunable trap resonator circuit 1020. In an embodiment, the values of the inductances 1026 and 1028 may be the same, or substantially similar, whereby the inductance at the node 1002 with the switch 1025 open may comprise substantially one half of the total inductance. In alternative embodiments, the values of the inductances 1026 and 1028 may be different, whereby the inductance with the switch 1025 open may present less than or more than one half of the total inductance to the signal on node 1002. In any embodiment, the values of the inductances 1026 and 1028 may be selected to determine the resonant frequency of the tunable trap resonator circuit 1020 both with the switch 1025 open and the switch 1025 closed. In this manner, the transmission poles and zeros of the tunable trap resonator circuit 1020 can be adjusted.

In all of the exemplary embodiments shown in FIGS. 8A, 8B, 9A, 9B, 10A and 10B, when the switch is OFF, the off capacitance, C_{off} of the switch will pull the response of the resonator slightly lower in frequency than the response with on capacitance. When the switch is turned ON, the small on resistance, Rₒₙ will make the overall inductance smaller and the frequency response will increase, thereby extending the tuning range. Although omitted for simplicity of illustration, a look up table would be created for each of the filter circuits of FIGS. 9A, 9B, 10A and 10B to control the values of the inductances and capacitances, as described above.

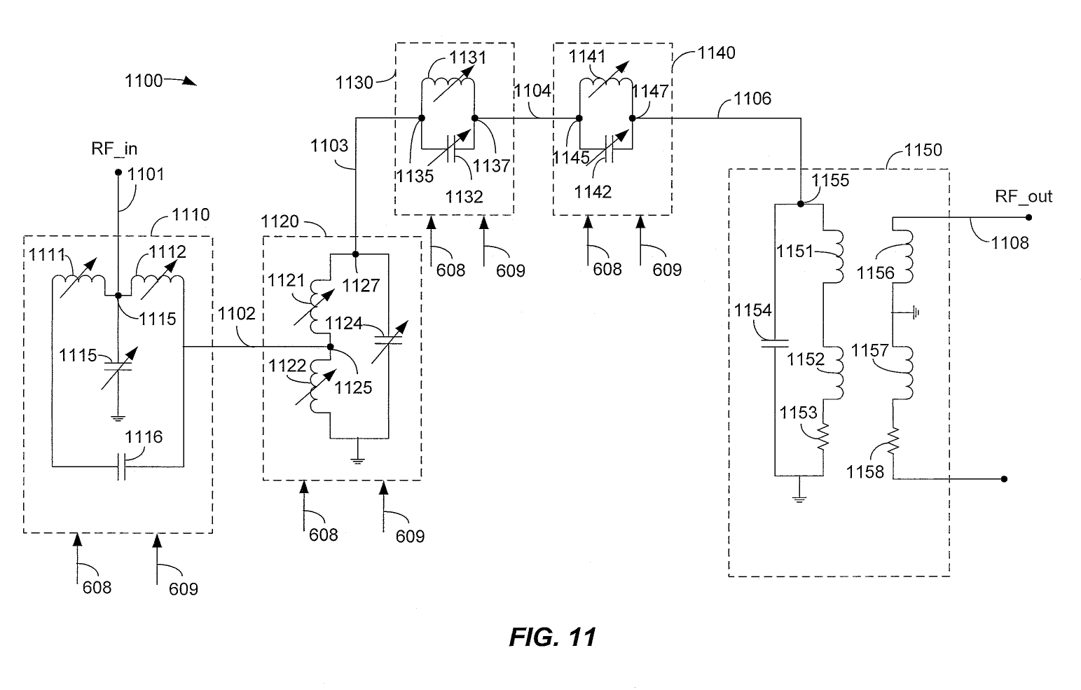

FIG. 11 is a schematic diagram illustrating an exemplary embodiment of a tunable filter circuit 1100. The filter circuit 1100 comprises a first tunable transmit (TX) notch filter circuit 1110, a tunable bandpass filter circuit 1120, a second tunable TX notch filter circuit 1130, a tunable WIFI notch filter circuit 1140 and a transformer 1150. The first tunable transmit TX notch filter circuit 1110, the second tunable TX notch filter circuit 1130, and the tunable WIFI notch filter circuit 1140 can be implemented using embodiments of the tunable notch resonator shown in FIG. 7A and FIG. 7B. The tunable bandpass filter circuit 1120 can be implemented using embodiments of the tunable bandpass resonator shown in FIG. 9A and FIG. 9B. Although not shown in FIG. 11, the tunable filter structure 1100 may also comprise an instance of a tunable trap resonator shown in FIG. 10A and FIG. 10B.

The first tunable TX notch filter circuit 1110 comprises an adjustable inductance 1111, an adjustable inductance 1112, an adjustable capacitance 1114 and a capacitance 1116. A radio frequency (RF) input signal, RF_in, is provided to the first tunable transmit TX notch filter circuit 1110 over connection 1101 to the node 1115 between the inductances 1111 and 1112.

The tunable bandpass filter circuit 1120 comprises an adjustable inductance 1121, an adjustable inductance 1122 and an adjustable capacitance 1124. The signal output of the first tunable TX notch filter circuit 1110 is provided over connection 1102 to the node 1125 between the adjustable inductance 1121 and the adjustable inductance 1122. The output of the tunable bandpass filter circuit 1120 is provided from the node 1127 between the adjustable inductance 1121 and the adjustable capacitance 1124 over connection 1103 to the second TX notch filter circuit 1130.

The second TX notch filter circuit 1130 comprises an adjustable inductance 1131 and an adjustable capacitance 1132. The output of the tunable bandpass filter circuit 1120 is provided to the node 1135 between the adjustable inductance 1131 and the adjustable capacitance 1132 over connection 1103. The output of the second TX notch filter circuit 1130 is provided from the node 1137 between the adjustable inductance 1131 and the adjustable capacitance 1132 over connection 1104.

The WIFI notch filter circuit 1140 comprises an adjustable inductance 1141 and an adjustable capacitance 1142. The output of the second TX notch filter circuit 1130 is provided to the node 1145 between the adjustable inductance 1141 and the adjustable capacitance 1142 over connection 1104. The output of the WIFI notch filter circuit 1140 is provided from the node 1147 between the adjustable inductance 1141 and the adjustable capacitance 1142 over connection 1106.

The transformer 1150 comprises a primary side having an inductance 1151, an inductance 1152 and a resistance 1153. The transformer 1150 comprises a secondary side having an inductance 1156, an inductance 1157 and a resistance 1158. The output of the WIFI notch filter circuit 1140 is provided to the node 1155 between the inductance 1151 and the capacitance 1152 over connection 1106. The output, RF_out, of the transformer 1150 is provided over the connection 1108.

In an exemplary embodiment, the filter response and characteristic of the first tunable TX notch filter circuit 1110, the tunable bandpass filter circuit 1120, the second tunable TX notch filter circuit 1130, and the tunable WIFI notch filter circuit 1140 can be adjusted using the first and second control signals over connections 608 and 609 (FIG. 6). In an exemplary embodiment in which a TX jammer or a WIFI jammer signal is detected and processed by the data processor 310 to develop the second control signal, Ctr1_2, in the jammer filter control circuit 374 (FIG. 3). In an embodiment, the first control signal, Ctr1_1, is used to set the desired filter characteristics of the of the first tunable TX notch filter circuit 1110, the tunable bandpass filter circuit 1120, the second tunable TX notch filter circuit 1130, and the tunable WIFI notch filter circuit 1140 based on a desired receive band. The second control signal, Ctr1_2 can be used to tailor the filter response based on the detected jammer power so that the signal rejection provided by the first tunable TX notch filter circuit 1110, the tunable bandpass filter circuit 1120, the second tunable TX notch filter circuit 1130, and the tunable WIFI notch filter circuit 1140 is proportional to the jammer signal, and has no greater insertion loss than needed to provide the desired signal rejection.

In an exemplary embodiment in which the wireless device 300 comprises a WIFI coexistence manager, the power level of the WIFI signal being transmitted is also a known. In other alternative embodiments, downconversion and signal processing circuitry in the wireless device 300 can be used to determine the jammer power level to develop the second control signal, Ctr1_2. Based on the jammer power level provided by the jammer filter control circuit 374, the adjustable inductances and the adjustable capacitances in the first tunable TX notch filter circuit 1110, the tunable bandpass filter circuit 1120, the second tunable TX notch filter circuit 1130, and the tunable WIFI notch filter circuit 1140 can be fine tuned to tailor the filter response characteristics to maximize signal rejection and minimize insertion loss.

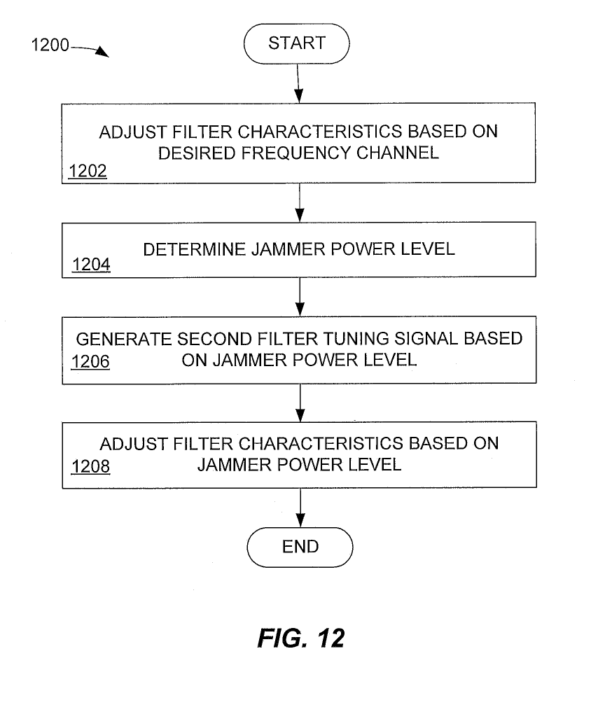

FIG. 12 is a flow chart describing an exemplary embodiment of a method for operating a tunable RF front-end architecture.

In block 1202, a tunable filter is adjusted based on a desired frequency channel by a first control signal, Ctr1_1, provided by the filter band control circuit 372 (FIG. 3).

In block 1204, a power level of a jammer signal is determined.

In block 1206, a second filter tuning signal, Ctr1_2, is generated by the jammer filter control circuit 374 based on the determined jammer power level.

In block 1208, the tunable filter is fine tuned by the second control signal, Ctr1_2, provided by the jammer filter control circuit 374 (FIG. 3). In an exemplary embodiment, the adjustable filter can be adjusted by the second control signal, Ctr1_2, to provide an appropriate amount of signal rejection to reject the jammer signal, while minimizing the amount of insertion loss of the filter.

The calibration and tuning methodology for tuning an adjustable filter described herein may be implemented on one or more ICs, analog ICs, RFICs, mixed-signal ICs, ASICs, printed circuit boards (PCBs), electronic devices, etc. The calibration and tuning methodology for tuning an adjustable filter may also be fabricated with various IC process technologies such as complementary metal oxide semiconductor (CMOS), N-channel MOS (NMOS), P-channel MOS (PMOS), bipolar junction transistor (BJT), bipolar-CMOS (BiCMOS), silicon germanium (SiGe), gallium arsenide (GaAs), heterojunction bipolar transistors (HBTs), high electron mobility transistors (HEMTs), silicon-on-insulator (SOI), etc.

An apparatus implementing the calibration and tuning methodology for tuning an adjustable filter described herein may be a stand-alone device or may be part of a larger device. A device may be (i) a stand-alone IC, (ii) a set of one or more ICs that may include memory ICs for storing data and/or instructions, (iii) an RFIC such as an RF receiver (RFR) or an RF transmitter/receiver (RTR), (iv) an ASIC such as a mobile station modem (MSM), (v) a module that may be embedded within other devices, (vi) a receiver, cellular phone, wireless device, handset, or mobile unit, (vii) etc.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A device, comprising:
a tunable filter having an adjustable inductance and an adjustable capacitance, the tunable filter having a first tuning input responsive to a first control signal related to filter frequency band information; and
the tunable filter having a second tuning input responsive to a second control signal related to a jammer signal.

2. The device of claim 1, wherein the first control signal comprises desired filter receive band information.

3. The device of claim 1, wherein the second control signal comprises jammer signal power level information.

4. The device of claim 1, wherein:
the tunable filter is configured to be adjusted to a desired receive band based on the first control signal; and
the tunable filter is configured to be adjusted to have a signal rejection proportional to a jammer signal power level based on the second control signal.

5. The device of claim 4, wherein the signal rejection has a corresponding insertion loss in a desired receive band.

6. The device of claim 5, wherein the insertion loss improves as the jammer signal power level diminishes.

7. The device of claim 1, wherein the second control signal is based on a power level of a transmit jammer signal.

8. The device of claim 7, wherein values for the adjustable inductance and the adjustable capacitance are related to the second control signal and are determined from a look up table having values for the adjustable inductance and the adjustable capacitance based on the power level of the transmit jammer signal.

9. The device of claim 8, wherein the adjustable filter is configured to have a signal rejection proportional to the power level of the transmit jammer signal.

10. The device of claim 9, wherein the adjustable filter is configured to have the signal rejection at a transmit frequency of the transmit jammer signal.

11. The device of claim 9, wherein the signal rejection has a corresponding insertion loss in a desired receive band.

12. The device of claim 11, wherein the insertion loss improves as the transmit jammer signal power level diminishes.

13. A method, comprising:
adjusting a tunable filter based on a first control signal comprising filter frequency band information;
determining a power level of a jammer signal; and
adjusting the tunable filter based on the determined jammer signal power level.

14. The method of claim 13, further comprising adjusting the tunable filter to have a signal rejection response proportional to the jammer signal power level.

15. The method of claim 13, further comprising adjusting the adjustable filter to have a signal rejection response proportional to the jammer signal power level and an insertion loss related to the jammer signal power level.

16. The method of claim 15, further comprising improving the insertion loss as jammer signal power level diminishes.

17. A device, comprising:
means for adjusting a tunable filter based on a first control signal comprising filter frequency band information;
means for determining a power level of a jammer signal; and
means for adjusting the tunable filter based on the determined jammer signal power level.

18. The device of claim 17, further comprising means for adjusting the tunable filter to have a signal rejection response proportional to the jammer signal power level.

19. The device of claim 17, further comprising means for adjusting the adjustable filter to have a signal rejection response proportional to the jammer signal power level and an insertion loss related to the jammer signal power level.

20. The device of claim 19, further comprising means for improving the insertion loss as jammer signal power level diminishes.
